(19) United States
(12) Patent Application Publication
(10) Pub. No.: US 2022/0113258 A1
(43) Pub. Date: Apr. 14, 2022

(54) TEST PAPER KIT FOR RAPID GRADED QUANTITATIVE DETECTION OF AROMATIC PRIMARY AMINE CONTENT IN ACIDIC SOLUTION AND APPLICATION THEREOF

(71) Applicant: DALIAN UNIVERSITY OF TECHNOLOGY, Dalian (CN)

(72) Inventors: Shufen ZHANG, Dalian (CN); Lei LI, Dalian (CN); Huaixi LIU, Dalian (CN); Rongwen LV, Dalian (CN); Bingtao TANG, Dalian (CN); Wei MA, Dalian (CN)

(21) Appl. No.: 17/645,013

(22) Filed: Dec. 17, 2021

Related U.S. Application Data
(63) Continuation-in-part of application No. PCT/CN2020/127451, filed on Nov. 9, 2020.

(30) Foreign Application Priority Data
Aug. 14, 2020 (CN) 202010819724.4

(51) Int. Cl. G01N 21/78

(52) U.S. Cl. CPC G01N 21/78

(57) ABSTRACT

Provided is a test paper kit for rapid graded quantitative detection of aromatic primary amine content in an acidic solution and an application thereof, and belongs to the field of detection. A test paper kit for rapid graded quantitative detection of aromatic primary amine content in an acidic solution, including 9 independent test paper sheets I-IX, wherein the test paper sheets are obtained by soaking filter paper in the following solutions respectively and then drying the filter paper: the test paper sheets I-III are soaked in alcoholic solutions of p-dimethylaminobenzaldehyde with three concentrations respectively; the test paper sheets IV-VI are soaked in alcoholic solutions of p-hydroxybenzaldehyde with three concentrations respectively, and the test paper sheets VII-IX are soaked in alcoholic solutions of p-methoxybenzaldehyde with three concentrations respectively.

### CROSS-REFERENCE TO RELATED APPLICATION

This application is a continuation-in-part of PCT International Application No. PCT/CN2020/127451, filed Nov. 9, 2020, which claims the benefit of priority from Chinese patent application no. 202010819724.4, filed Aug. 14, 2020, the contents of which are incorporated herein by reference in its entirety.

### FIELD OF TECHNOLOGY

The invention relates to a test paper kit for rapid graded quantitative detection of aromatic primary amine content in an acidic solution and an application thereof, and belongs to the field of detection.

### BACKGROUND

Diazotization is widely used in the organic synthesis of azo-type organic dyes, pigments, medicines and agricultural chemicals. The diazotization of water-soluble aromatic primary amine is carried out in an aqueous solution of aromatic amine using nitrous acid as a diazotization reagent. In the reaction system, nitric acid is generated in situ from sodium nitrite and hydrochloric acid, which in theory needs one molar equivalent of sodium nitrite and two molar equivalents of hydrochloric acid. In order to keep the reaction acidic, excess hydrochloric acid is usually used, so the reaction system is strongly acidic. Aromatic amine exists in the reaction system in the form of reversible conversion equilibrium between aromatic amine hydrochloride and free aromatic amine. That is to say, when aromatic amine undergoes diazotization, the main organic compounds in the reaction system are free aromatic amine, aromatic amine hydrochloride and aromatic amine diazonium salt. Whether the diazotization is finished or not is mainly judged by whether aromatic amine exists in the reaction system.

Diazotization of most aromatic primary amines is rapid, and some aromatic primary amines even undergo diazotization immediately when they encounter diazotization reagents. When diazotization is carried out in a batch reactor, the velocities of mass transfer and heat transfer are slower than the reaction velocity of diazotization if the reaction volume is large. When the amount of acid or diazotization reagent in the reaction system is insufficient locally, the generated diazonium salt is easily converted into relatively stable trans-diazonium salt, or the locally generated diazonium salt is easily coupled with the adjacent unreacted aromatic primary amine in the system. The occurrence of these two side reactions will seriously affect the subsequent coupling reaction or other reactions, and then generate by-products, affecting the product quality.

Whether the diazotization is completed or not is judged as follows in industrial production: with sufficient diazotization reagent and acid, after sufficient reaction time, starch potassium iodide test paper is usually used to detect whether the diazotization reagent is present; and the starch potassium iodide test paper rapidly turns blue when meeting the diazotization reagent, indicating that there is still diazotization reagent in the system, which indirectly proves that the diazotization of aromatic primary amine is completed. This method of judging the completion of diazotization of aromatic primary amine indirectly has some uncertainty. First, if the diazotization reagent or acid content is insufficient, the starch potassium iodide test paper will not turn blue, which cannot indicate that the diazotization is completed. Second, nitrous acid as the diazotization reagent is easy to decompose, which also consumes the diazotization reagent; when there is no nitrous acid in the reaction solution, the starch potassium iodide test paper also does not turn blue, which does not indicate that the diazotization of aromatic primary amine is completed. Moreover, the starch potassium iodide test paper will turn blue in a few seconds when it meets water in the air, which further increases the uncertainty of the method of indirectly judging whether the diazotization is completed.

The solution of p-dimethylaminobenzaldehyde in acid and alcohol (Ehrlich reagent for short) is an effective reagent for direct rapid qualitative detection of whether aromatic primary amine exists in an acidic solution, that is, whether diazotization of aromatic primary amine is completed. In the detection, p-dimethylaminobenzaldehyde rapidly generates Schiff base with the amino group in aromatic primary amine under acidic condition and turns yellow, so that this is a rapid color development reaction, and the reaction equation is as follows:

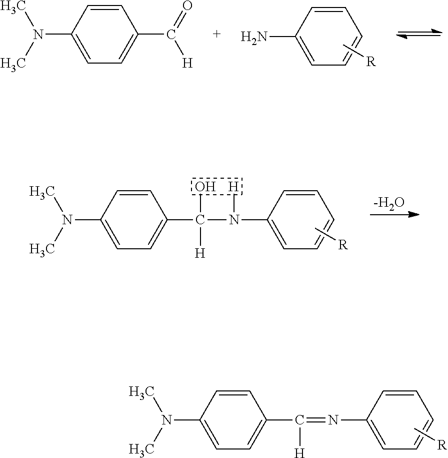

If all the aromatic primary amine in the reaction system has been diazotized, that is, there is no aromatic primary amine in the reaction solution, the reaction solution will not develop color when it meets the Ehrlich reagent; if the aromatic primary amine is not reacted completely, or even only about 0.01% by mass of aromatic primary amine remains, it will turn yellow when aromatic primary amine comes into contact with a small amount of the Ehrlich reagent. Therefore, the Ehrlich reagent is a rapid detection reagent for the completion of the diazotization of aromatic primary amine. Especially for the diazotization in batch reactors, if it is found through rapid detection using the Ehrlich reagent that the diazotization of aromatic primary amine has not been completed, under the condition of the existence of acid and diazotization reagent, the reaction time is usually prolonged to complete diazotization. Therefore, under the condition of ensuring the existence of acid or diazotization reagent in the diazotization system, the absence of aromatic primary amine in the reaction system as detected by the Ehrlich reagent is the most powerful evidence for the completion of diazotization.

Diazotization in the dye industry is mainly carried out in batch reactors of tens of cubic meters or even larger, where the velocities of mass transfer and heat transfer are slower than the reaction velocity of diazotization. As a result, in the reaction system, the unreacted aromatic primary amine is easily coupled with the generated diazonium salt to generate by-products, which affects the product quality. Therefore, in order to complete the reaction rapidly, in recent years, it is increasingly important in industrial applications to use the pipeline reactor to realize rapid mass transfer and heat transfer to complete diazotization. Although strictly controlling the amount of diazotization reagent and acid in diazotization can theoretically ensure the complete conversion of diazo components into diazonium salts, the monitoring of the reaction process is still an essential measure to control the conversion rate of aromatic primary amine in the pipeline reactor and avoid poor product quality.

Theoretically, substances with UV-vis absorption wavelength can be detected online by a UV-vis absorption spectrometer. Aromatic primary amine usually has ultraviolet absorption near 254 nm. For example, for p-aminobenzenesulfonic acid, para-ester, mono-condensate and di-condensate, the maximum absorption peaks appear at 248 nm, 265 nm, 238 nm and 292 nm, respectively; for their hydrochlorides, the maximum absorption peaks appear at 214 nm, 265 nm, 238 nm and 292 nm, respectively; and for their diazonium salts, the maximum absorption peaks appear at 220 nm, 217 nm, 212 nm and 212 nm, respectively, as shown in FIG. 1 to FIG. 4. In strongly acidic aqueous solutions, aromatic primary amines mainly exist in the form of hydrochlorides, and the absorption peaks of their hydrochlorides are covered by the absorption peak of their diazonium salts, so the accurate values of the maximum absorption wavelengths of their hydrochlorides cannot be obtained. As a result, it is impossible to track and monitor the diazotization process of aromatic primary amine in real time by UV-vis absorption spectroscopy.

The end point of diazotization can be determined by thin layer chromatography in an acidic developing agent, but it takes at least a few minutes from sampling, dispensing to color layer development even if the operation is smooth. In addition, this method can only qualitatively detect the completion of diazotization, but cannot be used as a quantitative detection method, so this method is not suitable for real-time detection of the concentration of aromatic amine. For detection by on-line liquid chromatography, the diazotization of aromatic amine is carried out in a strongly acidic aqueous solution which cannot directly enter the chromatographic column, and the aqueous reaction solution must be neutralized to weak acidity or neutrality before entering the chromatographic column. However, at the instant of neutralization of the diazonium salt solution, the coupling reaction between diazonium salt and non-diazotized aromatic amine will occur, and the chromatographic analysis will give results related to the aromatic amine left over after coupling, but not the non-diazotized aromatic amine, so it is impossible to use liquid chromatography for on-line detection of aromatic amine residue in the process of diazotization. The characteristic peak of aromatic amine hydrochloride can be detected by on-line infrared analyzer. However, the infrared analyzer has low detection sensitivity and can only quantitatively detect compounds with characteristic peak at concentrations above 5%, and cannot give reliable quantitative detection results for samples with mass concentrations below 1%.

In order to make the diazotization completed in the pipeline reactor meet the requirements of industrial production as much as possible, the diazotization for producing azo dyes in the pipeline reactor must proceed in a high-concentration condition so as to be comparable to the batch reaction in terms of production cost. Therefore, there is an urgent need for a test paper kit for rapid graded quantitative detection of aromatic primary amine content in a high-concentration viscous diazotization reaction solution.

### SUMMARY OF THE INVENTION

The invention discloses a test paper kit for rapid graded quantitative detection of the graded quantitative content of aromatic primary amine in the process of diazotization of a high-concentration viscous solution. The test paper kit has the following advantages when used for detecting the process of diazotization: it can clearly distinguish among aromatic primary amine contents of ≥0.01%-<0.1%, ≥0.1%-<1% and ≥1% in mass concentration in the diazotization system to judge whether the reaction is completed or not; also, the accuracy of the graded quantitative detection results can be verified by color development within three time periods: 1 s, 2 s and 3 s.

An objective of the invention is to disclose a test paper kit for rapid graded quantitative detection of aromatic primary amine content in an acidic solution, wherein the test paper kit comprises 9 independent test paper sheets I-IX, and the test paper sheets are obtained by soaking filter paper in the following solutions respectively and then drying the filter paper.

The test paper sheets I, II and III are soaked in absolute ethanolic solutions of p-dimethylaminobenzaldehyde with concentrations of 11.9-14.9 g/L, 4.5-7.5 g/L and 1.8-2.1 g/L, respectively;

The test paper sheets IV, V and VI are soaked in absolute ethanolic solutions of p-hydroxybenzaldehyde with concentrations of 32.0-34.9 g/L, 26.8-29.0 g/L and 12.2-23.0 g/L, respectively;

The test paper sheets VII, VIII and IX are soaked in absolute ethanolic solutions of p-methoxybenzaldehyde with concentrations of 31.0-35.4 g/L, 27.2-28.0 g/L and 14.0-25.0 g/L, respectively.

According to the invention, the color development time of the test paper sheets I, IV and VII is within 1 s; the color development time of the test paper sheets II, V and VIII is within 2 s; and the color development time of the test paper sheets III, VI and IX is within 3 s.

The “color development time” in the invention, for example, “color development time within 2 s” means that the color development time is 2 s or less than 2 s. Other expressions are the same as explained above.

According to the present invention, “aromatic primary amine” refers to aromatic primary amine compounds, and specifically refers to compounds with the following characteristics: —NH₂ group connected to an aromatic hydrocarbon, the structure of the aromatic hydrocarbon containing one or more benzene rings, and nitrogen atoms directly connected with carbon atoms of the benzene rings by chemical bonds. The aromatic primary amine according to the present invention is preferably o-aminobenzenesulfonic acid, m-aminobenzenesulfonic acid, p-aminobenzenesulfonic acid, para-ester, meta-ester, mono-condensate of cyanuric chloride and m-phenylenediamine sulfonic acid, and di-condensate of cyanuric chloride, para-ester and m-phenylenediamine sulfonic acid.

Preferably, disclosed is a test paper kit for rapid graded quantitative detection of aromatic primary amine content in an acidic solution, wherein the test paper kit comprises 9 independent test paper sheets I-IX, and the test paper sheets are obtained by soaking filter paper in the following solutions respectively and drying the filter paper.

The test paper sheets I, II and III are soaked in absolute ethanolic solutions of p-dimethylaminobenzaldehyde with concentrations of 12.5 g/L, 7.0 g/L and 2.0 g/L respectively;

The test paper sheets IV, V and VI are soaked in absolute ethanolic solutions of p-hydroxybenzaldehyde with concentrations of 34.0 g/L, 28.0 g/L and 20.0 g/L respectively;

The test paper sheets VII, VIII and IX are soaked in absolute ethanolic solutions of p-methoxybenzaldehyde with concentrations of 34.0 g/L, 27.5 g/L and 23.0 g/L respectively.

The test paper kit of the invention is obtained by soaking filter paper in the corresponding solutions for 20-300 min and then drying the filter paper; wherein the soaking time of the filter paper in the solution is subject to the evenly soaking of the filter paper by the solution, and those skilled in the art can obtain the soaking time according to judgment. Preferably, the test paper kit comprises 9 independent test paper sheets I-IX which are obtained by soaking filter paper in the above solutions for 20-60 min respectively and then air drying at room temperature.

Another objective of the invention is to disclose a method for rapid graded quantitative detection of aromatic primary amine content in an acidic solution by using the aforesaid test paper kit.

Disclosed is a method for rapid graded quantitative detection of aromatic primary amine content in an acidic solution, comprising the following steps: adding dropwise an acidic solution containing aromatic primary amine to-be-detected onto the 9 test paper sheets I-IX respectively, and observing whether the test paper sheets change color or not;

When only 3 test paper sheets I-III (I, II, III) change color, the mass concentration of aromatic primary amine in the aqueous solution to-be-detected is 0.01%-<0.1%;

When only 6 test paper sheets I-VI (I, II, III, IV, V, VI) change color, the mass concentration of aromatic primary amine in the aqueous solution to-be-detected is 0.1%-<1%; and

When all 9 test paper sheets I-IX (I, II, III, IV, V, VI, VII, VIII, IX) change color, the mass concentration of aromatic primary amine in the aqueous solution to-be-detected is ≥1%.

In the method for rapid graded quantitative detection of aromatic primary amine content in an acidic solution of the present invention, the test paper changing color means that the test paper changes from white to yellow.

The “aromatic primary amine” of the present invention includes, but is not limited to, o-aminobenzenesulfonic acid, m-aminobenzenesulfonic acid, p-aminobenzenesulfonic acid, para-ester, meta-ester, mono-condensate of cyanuric chloride and m-phenylenediamine sulfonic acid, and di-condensate of cyanuric chloride, para-ester and m-phenylenediamine sulfonic acid.

In the above technical solutions, the pH of the acidic solution is <3.

In the above technical solutions, when only 3 test paper sheets I-III change color, the mass concentration of aromatic primary amine in the aqueous solution to-be-detected is 0.01% (including 0.01%)-<0.1% (excluding 0.1%);

When only 6 test paper sheets I-VI change color, the mass concentration of aromatic primary amine in the aqueous solution to-be-detected is 0.1% (including 0.1%)-<1% (excluding 1%);

When all 9 test paper sheets I-IX change color, the mass concentration of aromatic primary amine in the aqueous solution to be detected is ≥1%.

Another objective of the present invention is to disclose a method for rapid graded quantitative detection of aromatic primary amine content in a diazotization reaction solution by using the aforesaid test paper kit.

Disclosed is a method for rapid graded quantitative detection of aromatic primary amine content in a diazotization reaction solution, comprising the following steps: adding dropwise a diazotization reaction solution to-be-detected onto the 9 test paper sheets I-IX respectively, and observing whether the test paper sheets change color or not;

When only 3 test paper sheets I-III change color, the mass concentration of aromatic primary amine in the reaction solution to-be-detected is 0.01%-<0.1%;

When only 6 test paper sheets I-VI change color, the mass concentration of aromatic primary amine in the reaction solution to-be-detected is 0.1%-<1%; and

When all 9 test paper sheets I-IX change color, the mass concentration of aromatic primary amine in the reaction solution to-be-detected is ≥1%.

In the above technical solution, when only 3 test paper sheets I-III change color, the mass concentration of aromatic primary amine in the reaction solution to-be-detected is 0.01% (including 0.01%)-<0.1% (excluding 0.1%);

When only 6 test paper sheets I-VI change color, the mass concentration of aromatic primary amine in the reaction solution to-be-detected is 0.1% (including 0.1%)-<1% (excluding 1%); and

When all 9 test paper sheets I-IX change color, the mass concentration of aromatic primary amine in the reaction solution to-be-detected is ≥1%.

Furthermore, the initial aromatic amine mass concentration of the diazotization in the continuous reactor is higher than 5%, even more than 25%.

In the present invention, for the continuous reactor, the diazotization reaction solution with an input amount of aromatic amine as the diazo component equal to or higher than 5% (w/w) is called a high-concentration reaction solution, and the viscosity of the high-concentration reaction solution is higher than that of the diazotization reaction solution which with an input amount of diazo component of 1%.

In view of the requirement that the content of aromatic primary amine needs to be rapidly detected when a high-concentration viscous diazotization reaction solution flows and reacts in a pipeline reactor rapidly, the present invention discloses a test paper kit for rapid graded quantitatively detection of aromatic primary amine content in the diazotization reaction solution.

The design principle of the invention is as follows:

(1) According to the principle that the alcoholic solution of p-dimethylaminobenzaldehyde undergoes Schiff base reaction with aromatic primary amine under acidic conditions to turn yellow, it is designed in the present invention to use an absolute alcoholic solution of p-dimethylaminobenzaldehyde to detect acidic aqueous solutions containing aromatic primary amine with mass concentrations ≥0.01% to <0.1% in high-concentration viscous acidic reaction solutions, and to control the concentration of the alcoholic solution of p-dimethylaminobenzaldehyde, so that it changes color within 1 s, 2 s and 3 s when contact with a high-concentration aromatic primary amine diazonium salt solution, to ensure the accuracy of the test results.

(2) p-Hydroxybenzaldehyde can also undergo Schiff base reaction with aromatic primary amine to turn yellow, which can also be used for detecting aromatic primary amine. However, the sensitivity of the Schiff base reaction between p-hydroxybenzaldehyde and aromatic primary amine is lower than that of the reaction between p-dimethylaminobenzaldehyde and aromatic primary amine. Therefore, it is designed in the invention to use an absolute ethanolic solution of p-hydroxybenzaldehyde to detect acidic aqueous solutions containing aromatic primary amine of ≥0.1% to <1% in high-concentration viscous reaction solutions, and to control the concentration of the absolute ethanolic solution of p-hydroxybenzaldehyde so as to change color when coming into contact with high-concentration aromatic primary amine diazonium salt solutions within 1 s, 2 s and 3 s to ensure the accuracy of the detection results.

(3) p-Methoxybenzaldehyde can also undergo Schiff base reaction with aromatic primary amine to turn yellow, which can also be used for detecting aromatic primary amine. However, the sensitivity of Schiff base reaction between p-methoxybenzaldehyde and aromatic primary amine is further lower. Therefore, it is designed in the invention to use an absolute ethanolic solution of p-methoxybenzaldehyde to detect acidic aqueous solutions containing aromatic primary amine of ≥1% in high-concentration viscous reaction solutions, and to control the concentration of the absolute ethanolic solution of p-methoxybenzaldehyde so as to change color when coming into contact with high-concentration aromatic primary amine diazonium salt solutions within 1 s, 2 s and 3 s to ensure the accuracy of the detection results.

Based on the above principle, the invention provides a test paper kit for rapid graded quantitative detection of the graded quantitative content of aromatic primary amine in the process of diazotization in high-concentration viscous solutions.

The invention has the following beneficial effects. The present disclosure discloses a test paper kit for rapid graded quantitative detection of aromatic primary amine content in a high-concentration viscous diazotization reaction solution and a method for preparing the same, and belongs to the field of fine chemical industry. The test paper kit is advantageous in that, by using three aromatic aldehyde derivatives having different reaction sensitivities with aromatic primary amine, with the content of the three aromatic aldehyde derivatives being in three ranges including high, medium and low dosages respectively, it can distinguish among the graded ranges of aromatic primary amine content in the diazotization reaction solution through a single rapid detection, and even realizes rapid graded quantitative detection for mass concentrations of aromatic primary amine of ≥0.01% to <0.1%, ≥0.1% to <1%, and ≥1% in high-concentration viscous aqueous solutions. Also, it ensures the accuracy of the detection results by rapid color development for three times at different time. The test paper kit can be used for rapid detection of quantitative graded ranges of aromatic primary amine content in aromatic primary amine diazotization reaction, and especially meets the requirement of rapid graded quantitative detection of the content of aromatic primary amine as a raw material in the process of high-concentration viscous diazotization in a pipeline reactor.

### BRIEF DESCRIPTION OF THE DRAWINGS

FIG. 1 shows UV absorption curves of p-aminobenzenesulfonic acid, p-aminobenzenesulfonic acid hydrochloride and p-aminobenzenesulfonic acid diazonium salt with a concentration of 0.01 g/L;

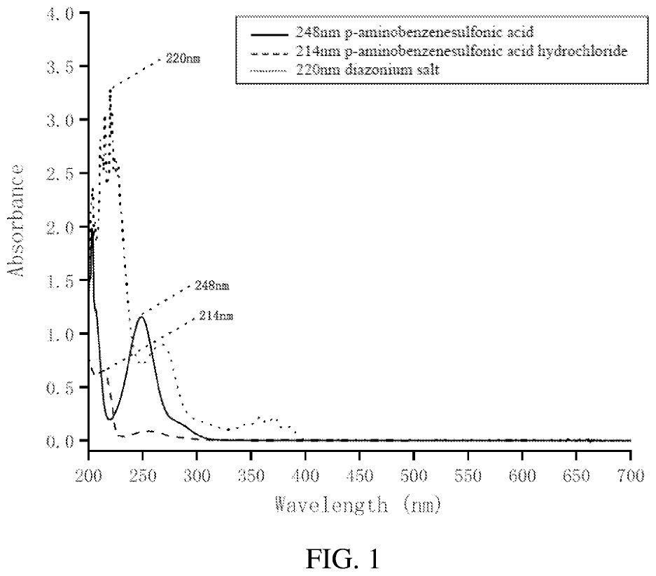

FIG. 2 shows UV absorption curves of para-ester, para-ester hydrochloride and para-ester diazonium salt with a concentration of 0.01 g/L;

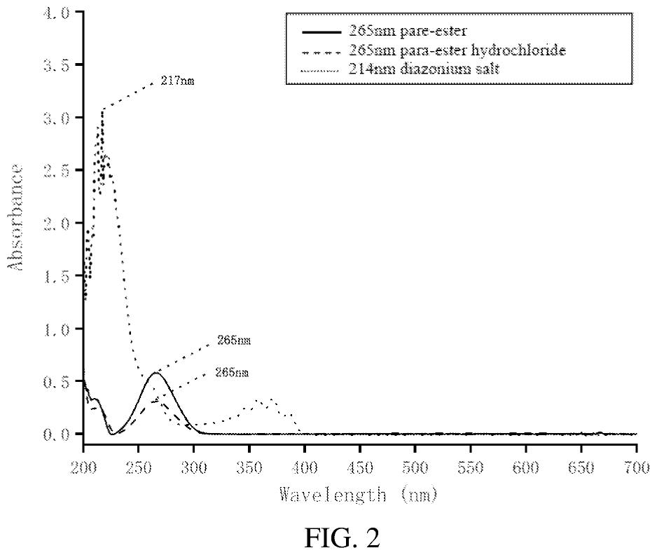

FIG. 3 shows UV absorption curves of mono-condensate of cyanuric chloride and m-phenylenediamine sulfonic acid (mono-condensate for short), mono-condensate hydrochloride and mono-condensate diazonium salt with a concentration of 0.01 g/L; and

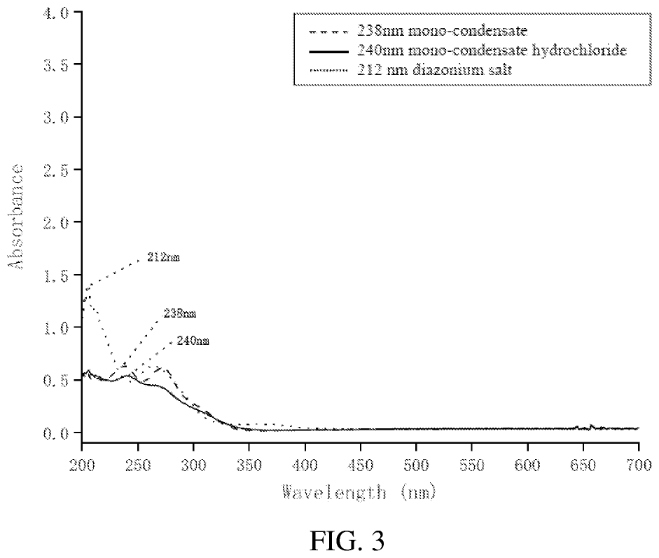

FIG. 4 shows UV absorption curves of di-condensate of cyanuric chloride, para-ester and m-phenylenediamine sulfonic acid (di-condensate for short), di-condensate hydrochloride and di-condensate diazonium salt with a concentration of 0.01 g/L.

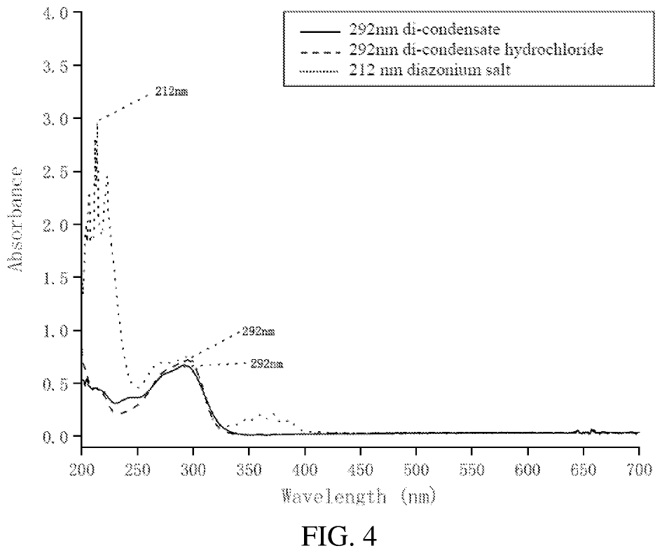

### DESCRIPTION OF THE EMBODIMENTS

The following non-limiting examples enable those of ordinary skilled in the art to understand the invention more fully, but do not limit the invention in any way.

Unless otherwise specified, the test methods described in the following examples are all conventional methods. Unless otherwise specified, all the reagents and materials are commercially available.

The concentrations of the absolute ethanolic solutions of p-dimethylaminobenzaldehyde, p-hydroxybenzaldehyde and p-methoxybenzaldehyde in the following examples are all in g/L; and the concentrations of aromatic primary amine derivatives are all in percentage by mass.

The implementation is as follows:

A test paper kit for rapid graded quantitative detection of aromatic primary amine content in an acidic solution, wherein the test paper kit comprises 9 independent test paper sheets I-IX, and the test paper sheets are respectively obtained by soaking filter paper in the following solutions and then drying the test paper;

The test paper sheets I, II and III are soaked in absolute ethanolic solutions of p-dimethylaminobenzaldehyde with concentrations of 11.9-14.9 g/L, 4.5-7.5 g/L and 1.8-2.1 g/L, respectively;

The test paper sheets IV, V and VI are soaked in absolute ethanolic solutions of p-hydroxybenzaldehyde with concentrations of 32.0-34.9 g/L, 26.8-29.0 g/L and 12.2-23.0 g/L, respectively; and

The test paper sheets VII, VIII and IX are soaked in absolute ethanolic solutions of p-methoxybenzaldehyde with concentrations of 31.0-35.4 g/L, 27.2-28.0 g/L and 14.0-25.0 g/L, respectively.

The preparation method is as follows:

(1) The three aromatic aldehyde derivatives are respectively prepared into 9 absolute ethanolic solutions with the aforesaid concentrations, including absolute ethanolic solutions of p-dimethylaminobenzaldehyde with three concentration ranges of 11.9-14.9 g/L, 4.5-7.5 g/L and 1.8-2.1 g/L; absolute ethanolic solutions of p-hydroxybenzaldehyde with three concentration ranges of 32.0-34.9 g/L, 26.8-29.0 g/L and 12.2-23.0 g/L; and absolute ethanolic solutions of p-methoxybenzaldehyde with three concentration ranges of 31.0-35.4 g/L, 27.2-28.0 g/L and 14.0-25.0 g/L;

(2) Common filter paper for experiments is soaked in the above solutions for 20-300 min, and after the filter paper is soaked evenly, the filter paper is taken out and hung until dry;

(3) The combined test paper sheets arranged in parallel can be cut into strips that are 8 mm wide and 30 mm long (not limited to this size), arranged in order of p-dimethylaminobenzaldehyde, p-hydroxybenzaldehyde and p-methoxybenzaldehyde, with the concentrations of each aromatic aldehyde derivative arranged from high to low; an anti-leakage paper sheet is provided between every two layers of test filter paper, a light-shielding cardboard is provided on the top layer and bottom layer, respectively, and the test paper sheets are finally bound together. Alternatively, the filter paper soaked with the alcoholic solutions of aromatic aldehyde derivative is cut into strips that are 8 mm wide and 15 mm long (but not limited to this size), arranged in three rows in order of p-dimethylaminobenzaldehyde, p-hydroxybenzaldehyde and p-methoxybenzaldehyde, with each row of test paper sheets arranged according to the content of the corresponding aromatic aldehyde derivative from high to low, an anti-leakage paper sheet is provided between every two layers of test filter paper, a light-shading cardboard is provided on the top layer and bottom layer respectively, and finally the test paper sheets are bound together.

The test paper kit is used as follows: in the process of diazotization, the reaction solution is rapidly added dropwise onto the 9 test paper sheets arranged as described above using a dropping pipette at one time. When only the first 3 test paper sheets (No. I, II and III) change color, indicating the content of residual aromatic primary amine in the reaction solution is less than 0.1%, the reaction can be considered as complete; when the first 6 test paper sheets (No. I, II, III, IV, V and VI) change color, indicating the content of residual aromatic primary amine in the reaction solution is less than 1%, the reaction can be approximately considered as complete; and if all the 9 test paper sheets (No. I, II, III, IV, V, VI, VII, VIII and IX) change color, indicating the content of residual aromatic primary amine in the reaction solution is higher than or equal to 1%, for the diazotization reaction in the pipeline reactor, it can be considered that the diazotization reaction is not completed.

The first, fourth and seventh test paper sheets in the test paper kit can develop color in less than 1 s, realizing rapid color development; and the test paper sheets which develop color within 2 s and 3 s respectively further confirm the accuracy of the above rapid detection results within 1 s.

### Example 1

(1) o-Aminobenzenesulfonic acid, m-aminobenzenesulfonic acid, p-aminobenzenesulfonic acid, para-ester, meta-ester, mono-condensate of cyanuric chloride and m-phenylenediamine sulfonic acid (mono-condensate for short), di-condensate of cyanuric chloride and para-ester and m-phenylenediamine sulfonic acid (di-condensate for short) were respectively prepared into aqueous solutions with 0.01% mass concentration, and the pH of the solution was adjusted to be lower than 3 by dilute hydrochloric acid.

(2) p-Dimethylaminobenzaldehyde was prepared into 1.5 g/L-14.9 g/L solutions in absolute ethanol as shown in Table 1 with absolute ethanol; p-hydroxybenzaldehyde was prepared into 30.0 g/L-34.9 g/L solutions in absolute ethanol as shown in Table 2; and p-methoxybenzaldehyde was prepared into 31.0 g/L-35.4 g/L solutions in absolute ethanol as shown in Table 3.

(3) The acidic aqueous solution of aromatic primary amine with 0.01% mass concentration was added dropwise on the filter paper using a dropping pipette. After the solution was soaked and spread out on the filter paper, the absolute ethanolic solutions of p-dimethylaminobenzaldehyde with different concentrations were respectively added dropwise on the filter paper. The yellowing time of each of the two kinds of solution at the filter paper seepage circle was observed and recorded in Table 1.

(4) The acidic aqueous solution of aromatic primary amine with 0.01% mass concentration was added dropwise on the filter paper using a dropping pipette. After the solution was soaked and spread out on the filter paper, the absolute ethanolic solutions of p-hydroxybenzaldehyde and p-methoxybenzaldehyde with different concentrations were added dropwise on the filter paper respectively. The yellowing time of the acidic aqueous solution of aromatic primary amine and the absolute ethanolic solutions of two aromatic aldehydes at the filter paper seepage circle was observed, and the results showed that they all did not change color within 10 s, the results were recorded in Table 2 and Table 3.

TABLE 1
The color development time of detecting the 0.01% aromatic primary amine solution with
p-dimethylaminobenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-dimethylaminobenzaldehyde | 1.5 | 3.03 | 2.81 | 2.62 | 1.75 | 2.01 | 3.16 | 2.87 |
| | 1.8 | 2.95 | 2.54 | 2.38 | 1.68 | 1.88 | 2.89 | 2.75 |
| | 2.1 | 2.87 | 2.25 | 2.17 | 1.63 | 1.49 | 2.75 | 2.68 |
| | 2.5 | 2.41 | 1.93 | 1.69 | 1.12 | 1.35 | 2.35 | 2.32 |
| | 4.0 | 2.05 | 1.37 | 1.38 | 0.81 | 1.18 | 2.1 | 2.18 |
| | 4.5 | 1.85 | 1.28 | 1.28 | 0.75 | 1.12 | 1.99 | 2.13 |
| | 5.0 | 1.58 | 1.21 | 1.3 | 0.7 | 1.1 | 2.1 | 2.03 |
| | 7.5 | 1.4 | 1.2 | 1.4 | 0.6 | 0.8 | 1.92 | 1.4 |
| | 8.0 | 1.05 | 0.92 | 1.07 | 0.5 | 0.61 | 1.03 | 1.11 |
| | 11.9 | 0.91 | 0.8 | 0.8 | 0.3 | 0.2 | 0.99 | 0.97 |
| | 12.5 | 0.73 | 0.66 | 0.57 | <0.2 | <0.2 | 0.84 | 0.72 |
| | 13.0 | 0.41 | 0.38 | 0.35 | <0.2 | <0.2 | 0.75 | 0.31 |
| | 14.9 | 0.25 | 0.3 | 0.2 | <0.2 | <0.2 | 0.5 | instant |

TABLE 2
The color development time of detecting the 0.01% aromatic primary amine solution with
p-hydroxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-hydroxybenzaldehyde | 30.0 | — | — | — | — | — | — | — |
| | 31.7 | — | — | — | — | — | — | — |
| | 32.0 | — | — | — | — | — | — | — |
| | 34.9 | — | — | — | — | — | — | — |

*: “—” represent non-discolouring within 10 s

TABLE 3
The color development time of detecting the 0.01% aromatic primary amine solution with
p-methoxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-methoxybenzaldehyde | 31.0 | — | — | — | — | — | — | — |
| | 32.0 | — | — | — | — | — | — | — |
| | 33.0 | — | — | — | — | — | — | — |
| | 35.4 | — | — | — | — | — | — | — |

*: “ ” represent non-discolouring within 10 s

### Example 2

(1) o-Aminobenzenesulfonic acid, m-aminobenzenesulfonic acid, p-aminobenzenesulfonic acid, para-ester, meta-ester, mono-condensate of cyanuric chloride and m-phenylenediamine sulfonic acid (mono-condensate for short), di-condensate of cyanuric chloride and para-ester and m-phenylenediamine sulfonic acid (di-condensate for short) were respectively prepared into aqueous solutions with 0.1% mass concentration, and the pH of the solution was adjusted to be lower than 3 by dilute hydrochloric acid.

(2) p-Dimethylaminobenzaldehyde was prepared into 1.5 g/L-4.0 g/L solutions in absolute ethanol as shown in Table 4 with absolute ethanol; p-hydroxybenzaldehyde was prepared into 11.6 g/L-34.9 g/L solutions in absolute ethanol as shown in Table 5; and p-methoxybenzaldehyde was prepared into 31.0 g/L-35.4 g/L solutions in absolute ethanol as shown in Table 6.

(3) The acidic aqueous solution of aromatic primary amine with 0.1% mass concentration was added dropwise on the filter paper using a dropping pipette. After the solution was soaked and spread out on the filter paper, the absolute ethanolic solutions of p-dimethylaminobenzaldehyde with different concentrations were respectively added dropwise on the filter paper. The yellowing time of the two kinds of solution at the filter paper seepage circle was observed and recorded in Table 4. Even when the absolute ethanolic solution of p-dimethylaminobenzaldehyde was as low as 1.5 g/L, the yellowing time of the two kinds of solution at the filter paper seepage circle was still less than 3 s; when the concentration of the absolute ethanolic solution of p-dimethylaminobenzaldehyde was 2.5 g/L, the yellowing time of the two kinds of solution at the filter paper seepage circle was less than 0.2 s, which was regarded as instantaneous color development.

(4) The acidic aqueous solution of aromatic primary amine with 0.1% mass concentration was added dropwise on the filter paper using a dropping pipette. After the solution was soaked and spread out on the filter paper, the absolute ethanolic solutions of p-hydroxybenzaldehyde with different concentrations were added dropwise on the filter paper. The yellowing time of the two kinds of solutions at the filter paper seepage circle was observed and recorded in Table 5.

(5) The acidic aqueous solution of aromatic primary amine with 0.1% mass concentration was added dropwise on the filter paper using a dropping pipette. After the solution was soaked and spread out on the filter paper, the absolute ethanolic solutions of p-methoxybenzaldehyde with different concentrations were added dropwise on the filter paper. The yellowing time of the two kinds of solution at the filter paper seepage circle was observed. The results showed that the color did not change within 10 s in all the cases and recorded in Table 6.

TABLE 4
The color development time of detecting the 0.1% aromatic primary amine solution with
p-methoxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| laminoben | 1.5 | 2.98 | 1.40 | 1.71 | 0.32 | 2.23 | 2.21 | 2.43 |
| | 1.8 | 2.20 | 0.99 | 1.29 | 0.28 | 1.34 | 1.93 | 2.04 |
| | 2.1 | 1.53 | 0.64 | 0.52 | 0.25 | 0.78 | 1.53 | 1.71 |
| | 2.5 | <0.2 | <0.2 | <0.2 | <0.2 | <0.2 | <0.2 | <0.2 |
| | 4.0 | <0.2 | <0.2 | <0.2 | <0.2 | <0.2 | <0.2 | <0.2 |

TABLE 5
The color development time of detecting the 0.1% aromatic primary amine solution with
p-hydroxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-hydroxybenzaldehyde | 11.6 | 3.13 | 3.28 | 2.96 | 2.79 | 2.97 | 2.94 | 3.02 |
| | 12.2 | 2.95 | 3.02 | 2.86 | 2.44 | 2.97 | 2.82 | 2.93 |
| | 15.0 | 2.67 | 2.86 | 2.55 | 2.38 | 2.89 | 2.67 | 2.72 |
| | 17.0 | 2.41 | 2.61 | 2.36 | 2.28 | 2.77 | 2.40 | 2.46 |
| | 20.0 | 2.35 | 2.45 | 2.24 | 2.29 | 2.54 | 2.21 | 2.35 |
| | 23.0 | 2.12 | 2.31 | 2.07 | 2.24 | 2.39 | 2.06 | 2.38 |
| | 24.4 | 2.01 | 2.17 | 1.96 | 2.21 | 1.99 | 1.98 | 2.41 |
| | 25.0 | 1.75 | 1.92 | 1.68 | 2.17 | 1.78 | 1.89 | 2.26 |
| | 26.0 | 1.65 | 1.64 | 1.55 | 2.06 | 1.59 | 1.85 | 1.98 |
| | 26.8 | 1.45 | 1.25 | 1.38 | 2.0 | 1.4 | 1.77 | 1.98 |
| | 28.0 | 1.38 | 1.17 | 1.25 | 1.73 | 1.35 | 1.42 | 1.75 |
| | 29.0 | 1.11 | 1.06 | 1.21 | 1.46 | 1.27 | 1.00 | 1.18 |
| | 30.0 | 0.84 | 0.75 | 1.16 | 1.05 | 0.82 | 0.74 | 1.06 |
| | 31.7 | 0.7 | 0.6 | 1.13 | 0.92 | 0.4 | 0.65 | 0.81 |
| | 32.0 | 0.61 | 0.54 | 0.91 | 0.82 | 0.33 | 0.57 | 0.69 |
| | 34.9 | <0.2 | <0.2 | 0.52 | <0.2 | <0.2 | <0.2 | <0.2 |

TABLE 6
The color development time of detecting the 0.1% aromatic primary amine solution with
p-methoxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-methoxybenzaldehyde | 31.0 | — | — | — | — | — | — | — |
| | 32.0. | — | — | — | — | — | — | — |
| | 33.0 | — | — | — | — | — | — | — |
| | 35.4 | — | — | — | — | — | — | — |

*: “—” represent non-discolouring within 10 s

### Example 3

(1) p-Aminobenzenesulfonic acid, o-aminobenzenesulfonic acid, m-aminobenzenesulfonic acid, para-ester, meta-ester, mono-condensate of cyanuric chloride and m-phenylenediamine sulfonic acid (mono-condensate for short), di-condensate of cyanuric chloride and para-ester and m-phenylenediamine sulfonic acid (di-condensate for short) were respectively prepared into aqueous solutions with 1% mass concentration, and the pH of the solution was adjusted to be lower than 3 by dilute hydrochloric acid.

(2) p-Dimethylaminobenzaldehyde was prepared into 1.5 g/L-2.1 g/L solutions in absolute ethanol as shown in Table 7 with absolute ethanol; p-hydroxybenzaldehyde was prepared into 11.6 g/L-17.0 g/L solutions in absolute ethanol as shown in Table 8; and p-methoxybenzaldehyde was prepared into 13.6 g/L-35.4 g/L solutions in absolute ethanol as shown in Table 9.

(3) The acidic solution of aromatic primary amine with 1% mass concentration was added dropwise on the filter paper using a dropping pipette. After the solution was soaked and spread out on the filter paper, the absolute ethanolic solutions of p-dimethylaminobenzaldehyde with different concentrations were respectively added dropwise on the filter paper. The yellowing time of the two kinds of solution at the filter paper seepage circle was observed and recorded in Table 7. Even if the absolute ethanolic solution of p-dimethylaminobenzaldehyde was as low as 1.5 g/L, the yellowing time of the two solutions at the filter paper seepage circle was still less than 0.2 s, which was regarded as instantaneous color development.

(4) The acidic aqueous solution of aromatic primary amine was added dropwise on the filter paper using a dropping pipette. After the solution was is soaked and spread out on the filter paper, the absolute ethanolic solutions of p-hydroxybenzaldehyde with different concentrations were respectively added dropwise on the filter paper. The yellowing time of the two kinds of solution at the seepage circle was observed and recorded in Table 8. Even when the solution of p-dimethylaminobenzaldehyde in absolute ethanol was as low as 12.2 g/L, the yellowing time of the two solutions at the filter paper seepage circle was still less than 0.2 s, which was regarded as instantaneous color development.

(5) The acidic aqueous solution of aromatic primary amine with 1% mass concentration was added dropwise on the filter paper using a dropping pipette. After the solution was soaked and spread out on the filter paper, the absolute ethanolic solutions of p-methoxybenzaldehyde with different concentrations were respectively added dropwise on the filter paper. The yellowing time of the two kinds of solution at the filter paper seepage circle was observed and recorded in Table 9.

TABLE 7
The color development time of detecting the 1% aromatic primary amine solution with
p-methoxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-dimethylaminobenzaldehyde | 1.5 | <0.2 | <0.2 | <0.2 | <0.2 | <0.2 | <0.2 | <0.2 |
| | 1.8 | <0.2 | <0.2 | <0.2 | <0.2 | <0.2 | <0.2 | <0.2 |
| | 2.1 | <0.2 | <0.2 | <0.2 | <0.2 | <0.2 | <0.2 | <0.2 |

TABLE 8
The color development time of detecting the 1% aromatic primary amine solution with
p-hydroxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-hydrobenzaldehyde | 11.6 | 0.35 | 0.29 | 0.27 | 0.32 | 0.87 | 0.26 | 0.29 |
| | 12.2 | <0.2 | <0.2 | <0.2 | <0.2 | <0.2 | <0.2 | <0.2 |
| | 15.0 | <0.2 | <0.2 | <0.2 | <0.2 | <0.2 | <0.2 | <0.2 |
| | 17.0 | <0.2 | <0.2 | <0.2 | <0.2 | <0.2 | <0.2 | <0.2 |

TABLE 6
The color development time of detecting the 1% aromatic primary amine solution with
p-methoxybenzaldehyde solutions (unit: s)

| | | o-amino- | m-amino- | p-amino- | | | | |
|---|---|---|---|---|---|---|---|---|
| | | benzene- | benzene- | benzene- | | | | |
| | | sulfonic | sulfonic | sulfonic | para- | meta- | mono- | di- |
| | | acid | acid | acid | ester | ester | condensate | condensate |
| p-methoxybenzaldehyde | 13.6 | 2.71 | 2.87 | 2.35 | 2.56 | 2.98 | 3.01 | 2.98 |
| | 14.0 | 2.67 | 2.74 | 2.21 | 2.36 | 2.78 | 2.87 | 2.86 |
| | 24.0 | 2.54 | 2.65 | 2.15 | 2.31 | 2.76 | 2.56 | 2.35 |
| | 25.0 | 2.33 | 2.38 | 2.03 | 2.04 | 2.09 | 2.3 | 2.21 |
| | 26.0 | 1.70 | 1.84 | 1.87 | 1.66 | 1.85 | 2.06 | 2.17 |
| | 27.2 | 1.20 | 1.92 | 1.78 | 1.53 | 1.68 | 1.78 | 1.99 |
| | 28.0 | 1.15 | 1.21 | 1.5 | 1.3 | 1.42 | 1.12 | 1.65 |
| | 29.9 | 0.7 | 0.91 | 0.9 | 1.25 | 1.2 | 0.68 | 0.89 |
| | 30.0 | 0.65 | 0.72 | 0.59 | 1.12 | 1.11 | 0.53 | 0.77 |
| | 31.0 | 0.48 | 0.56 | 0.37 | 0.90 | 0.94 | 0.41 | 0.51 |
| | 32.0 | <0.2 | 0.41 | <0.2 | 0.68 | 0.8 | <0.2 | <0.2 |
| | 33.0 | <0.2 | <0.2 | <0.2 | 0.44 | 0.5 | <0.2 | <0.2 |
| | 35.4 | <0.2 | <0.2 | <0.2 | 0.35 | 0.4 | <0.2 | <0.2 |

### Example 4

(1) p-Dimethylaminobenzaldehyde was prepared into 12.5 g/L, 7.0 g/L and 2.0 g/L solutions in absolute ethanol respectively for later use.

(2) p-Hydroxybenzaldehyde was prepared into 34.0 g/L, 28.0 g/L and 20.0 g/L solutions in absolute ethanol respectively for later use.

(3) p-Methoxybenzaldehyde was prepared into 34.0 g/L, 27.5 g/L and 23.0 g/L solutions in absolute ethanol respectively for later use.

(4) The common filter paper for experiments was soaked in the above solutions. After the filter paper was soaked evenly, it was taken out and hung until dry, and then cut into a required size;

(5) The prepared filter paper soaked with the various aromatic aldehyde solutions in alcohol was cut into strips that were 8 mm wide, arranged in parallel in the order of the alcoholic solutions of p-dimethylaminobenzaldehyde with concentrations of 12.5 g/L, 7.0 g/L and 2.0 g/L (No. I, II and VIII), the alcoholic solutions of p-hydroxybenzaldehyde with concentrations of 34.0 g/L, 28.0 g/L and 20.0 g/L (No. IV, V, VI), and the alcoholic solutions of p-methoxybenzaldehyde with concentrations of 34.0 g/L, 27.5 g/L and 23.0 g/L (No. VII, VIII, IX). After the filter paper strips were neatly arranged, an anti-leakage paper sheet was provided between every two layers of filter paper with each filter paper strip being 30 mm long, and finally the sheets were bound together. Alternatively, the test paper soaked with three aromatic aldehyde solutions in alcohol was cut into strips that were 8 mm wide and 15 mm long, arranged in three rows in the order of the color development time from short to long and the aromatic primary amine concentration from low to high, an anti-leakage paper sheet was provided between every two layers of test filter paper, and finally the sheets were bound together. All of them are a test paper kit for rapid graded and quantitative detection of the content of residual diazo components in high-concentration viscous diazotization reaction solutions.

### Example 5

Acidic aqueous solutions of o-aminobenzenesulfonic acid with mass concentrations of 0.01%, 0.1% and 1% were prepared, respectively, and were rapidly added dropwise on the test paper kit prepared in Example 4. The results showed that the 0.01% acidic aqueous solution of o-aminobenzenesulfonic acid made the first three test paper sheets (No. I, II and III) in the test paper kit of the invention develop color rapidly within 1 s, 2 s and 3 s respectively. The 0.1% acidic aqueous solution of o-aminobenzenesulfonic acid made the first six test paper sheets (No. I, II, III, IV, V and VI) in the test paper kit of the invention rapidly develop color, wherein the yellow color of the first three test paper sheets (No. I, II and III) was obviously deeper than that of the fourth, fifth and sixth test paper sheets (No. IV, V and VI), the first (No. I) and fourth (No. IV) test paper sheets had a color development time of 1 s, the second (No. II) and fifth (No. V) test paper sheets had a color development time of 2 s, and the third (No. III) and sixth (No. VI) test paper sheets had a color development time of 3 s. The 1% acidic aqueous solution of o-aminobenzenesulfonic acid made all the test paper sheets in the test paper kit of the invention develop color rapidly, wherein the yellow color of the first three test paper sheets (No. I, II and III) was obviously deeper than that of the last six test paper sheets (No. IV, V, VI, VII, VIII and IX), and the yellow color of the fourth, fifth and sixth test paper sheets (No. IV, V, and VI) was obviously deeper than that of the seventh, eighth, and ninth test paper sheets (No. VII, VIII and IX); the first, fourth, and seventh test paper sheets (No. I, IV, and VII) had a color development time of 1 s, the second, fifth, and eighth test paper sheets (No. II, V, and VIII) had a color development time of 2 s, and the third, sixth, and ninth test paper sheets (No. III, VI, and IX) had a color development time of 3 s.

### Example 6

Acidic aqueous solutions of p-aminobenzenesulfonic acid with mass concentrations of 0.01%, 0.05%, 0.1%, 0.3%, 1% and 2% were prepared respectively, and were rapidly added dropwise on the test paper kit prepared in Example 4. The results showed that the 0.01% and 0.05% acidic aqueous solutions of p-aminobenzenesulfonic acid made the first three test paper sheets in the test paper kit of the invention develop color within 1 s, 2 s and 3 s, respectively. The 0.1% and 0.3% acidic aqueous solutions of p-aminobenzenesulfonic acid made the first six test paper sheets in the test paper kit of the invention develop color rapidly, and the yellow color of the first three test paper sheets was obviously deeper than that of the fourth, fifth and sixth test paper sheets; the color development time of the first and fourth test paper sheets was 1 s, the color development time of the second and fifth test paper sheets was 2 s, and the color development time of the third and sixth test paper sheets was 3 s. The 1% and 2% acidic aqueous solutions of p-aminobenzenesulfonic acid made all test paper sheets in the test paper kit of the invention develop color rapidly, the yellow color of the first three test paper sheets was obviously deeper than that of the last six test paper sheets, and the yellow color of the fourth, fifth and sixth test paper sheets was obviously deeper than that of the seventh, eighth and ninth test paper sheets; the first, fourth, and seventh test paper sheets developed color in 1 s, the second, fifth, and eighth test paper sheets in 2 s, and the third, sixth, and ninth test paper sheets in 3 s.

### Example 7

Acidic aqueous solutions of m-aminobenzenesulfonic acid with mass concentrations of 0.01%, 0.03%, 0.1%, 0.2%, 1% and 1.5% were prepared respectively, and were rapidly added dropwise on the test paper kit prepared in Example 4. The results showed that the 0.01% and 0.03% acidic aqueous solutions of m-aminobenzenesulfonic acid made the first three test paper sheets in the test paper kit of the invention develop color in 1 s, 2 s and 3 s, respectively. The 0.1% and 0.2% acidic aqueous solutions of m-aminobenzenesulfonic acid made the first six test paper sheets in the test paper kit of the invention develop color rapidly, and the yellow color of the first three test paper sheets was obviously deeper than that of the fourth, fifth and sixth test paper sheets; the first and fourth test paper sheets developed color in 1 s, the second and fifth test paper sheets in 2 s, and the third and sixth test paper sheets in 3 s. The 1% and 1.5% acidic aqueous solutions of m-aminobenzenesulfonic acid made all test paper sheets in the test paper kit of the invention develop rapidly, and the yellow color of the first three test paper sheets was obviously deeper than that of the last six test paper sheets, and the yellow color of the fourth, fifth and sixth test paper sheets was obviously deeper than that of the seventh, eighth and ninth test paper sheets; the first, fourth, and seventh test paper sheets developed color in 1 s, the second, fifth, and eighth test paper sheets in 2 s, and the third, sixth, and ninth test paper sheets in 3 s.

### Example 8

A para-ester solution was diluted to 0.01%, 0.07%, 0.1%, 0.6%, 1% and 2% respectively, and the pH of the solutions was adjusted to 3 with hydrochloric acid. Then, the solutions were rapidly added dropwise on the test paper kit prepared in Example 4 respectively. The results showed that the 0.01% and 0.07% para-ester acidic solutions made the first three test paper sheets in the test paper kit of the invention develop color in 1 s, 2 s and 3 s, respectively. The 0.1% and 0.6% para-ester acidic aqueous solutions made the first six test paper sheets in the test paper kit of the invention develop color rapidly, and the yellow color of the first three test paper sheets was obviously deeper than that of the fourth, fifth and sixth test paper sheets; the first and fourth test paper sheets developed color in 1 s, the second and fifth test paper sheets in 2 s, and the third and sixth test paper sheets in 3 s. The 1% and 2% para-ester acidic aqueous solutions made all test paper sheets in the test paper kit of the invention develop color rapidly, and the yellow color of the first three test paper sheets was obviously deeper than that of the last six test paper sheets, and the yellow color of the fourth, fifth and sixth test paper sheets was obviously deeper than that of the seventh, eighth and ninth test paper sheets; the first, fourth, and seventh test paper sheets developed color in 1 s, the second, fifth, and eighth test paper sheets in 2 s, and the third, sixth, and ninth test paper sheets in 3 s.

### Example 9

A meta-ester aqueous solution was diluted to 0.01%, 0.04%, 0.1%, 0.5%, 1% and 2%, respectively, and the pH of the solutions was adjusted to 3 with hydrochloric acid. Then, the solutions were rapidly added dropwise on the test paper kit prepared in Example 4 respectively. The results showed that the 0.01% and 0.04% meta-ester acidic solutions made the first three test paper sheets in the test paper kit of the invention develop color in 1 s, 2 s and 3 s respectively. The 0.1% and 0.5% meta-ester acidic aqueous solution made the first six test paper sheets in the test paper kit of the invention develop color rapidly, and the yellow color of the first three test paper sheets was obviously deeper than that of the fourth, fifth and sixth test paper sheets; the first and fourth test paper sheets developed color in 1 s, the second and fifth test paper sheets in 2 s, and the third and sixth test paper sheets in 3 s. The 1% and 2% meta-ester acidic aqueous solution made all test paper sheets in the test paper kit of the invention develop rapidly, the yellow color of the first three test paper sheets was obviously deeper than that of the last six test paper sheets, and the yellow color of the fourth, fifth and sixth test paper sheets was obviously deeper than that of the seventh, eighth and ninth test paper sheets; the first, fourth, and seventh test paper sheets developed color in 1 s, the second, fifth, and eighth test paper sheets in 2 s, and the third, sixth, and ninth test paper sheets in 3 s.

### Example 10

A mono-condensate acidic aqueous solution was diluted to 0.01%, 0.02%, 0.1%, 0.3%, 1% and 3%, respectively, and the solutions were rapidly added dropwise on the test paper kit prepared in Example 4 respectively. The results showed that the 0.01% and 0.02% mono-condensate acidic aqueous solutions made the first three test paper sheets in the test paper kit of the invention develop color in 1 s, 2 s and 3 s, respectively. The 0.1% and 0.3% mono-condensate acidic aqueous solution made the first six test paper sheets in the test paper kit of the invention develop color rapidly, and the yellow color of the first three test paper sheets was obviously deeper than that of the fourth, fifth and sixth test paper sheets; the first and fourth test paper sheets developed color in 1 s, the second and fifth test paper sheets in 2 s, and the third and sixth test paper sheets in 3 s. The 1% and 3% mono-condensate acidic aqueous solution made all test paper sheets in the test paper kit of the invention develop color rapidly, the yellow color of the first three test paper sheets was obviously deeper than that of the last six test paper sheets, and the yellow color of the fourth, fifth and sixth test paper sheets was obviously deeper than that of the seventh, eighth and ninth test paper sheets; the color development time is as follows: the first, fourth, and seventh test paper sheets developed color in 1 s, the second, fifth, and eighth test paper sheets in 2 s, and the third, sixth, and ninth test paper sheets in 3 s.

### Example 11

A di-condensate acidic aqueous solution was diluted to 0.01%, 0.05%, 0.1%, 0.5%, 1% and 1.5%, respectively, and the solutions were rapidly added dropwise on the test paper kit prepared in Example 4 respectively. The results showed that the 0.01% and 0.05% di-condensate acidic aqueous solutions made the first three test paper sheets in the test paper kit of the invention develop color in 1 s, 2 s and 3 s, respectively. The 0.1% and 0.5% di-condensate acidic aqueous solutions made the first six test paper sheets in the test paper kit of the invention develop color rapidly, and the yellow color of the first three test paper sheets was obviously deeper than that of the fourth, fifth and sixth test paper sheets; the first and fourth test paper sheets developed color in 1 s, the second and fifth test paper sheets in 2 s, and the third and sixth test paper sheets in 3 s. The 1% and 1.5% di-condensate acidic solution made all test paper sheets in the test paper kit of the invention develop rapidly, the yellow color of the first three test paper sheets was obviously deeper than that of the last six test paper sheets, and the yellow color of the fourth, fifth and sixth test paper sheets was obviously deeper than that of the seventh, eighth and ninth test paper sheets; the first, fourth, and seventh test paper sheets developed color in 1 s, the second, fifth, and eighth test paper sheets in 2 s, and the third, sixth, and ninth test paper sheets in 3 s.

### Example 12

p-Aminobenzenesulfonic acid was prepared into aqueous solutions with mass concentrations of 5%, 10%, 15%, 20% and 25%, respectively, and sodium nitrite and hydrochloric acid were respectively prepared into aqueous solutions according to a molar ratio of p-aminobenzenesulfonic acid:sodium nitrite:hydrochloric acid of 1:1.05:2.5. The feeding speed of the feeding pump was set to maintain the molar ratio of p-aminobenzenesulfonic acid:sodium nitrite:hydrochloric acid of 1:1.05:2.5. The three reaction solutions were fed into the reactor according to the aforesaid ratio, and the reaction results were detected by the test paper kit of the invention in 10 s, 20 s and 30 s, respectively as the materials flowed through the reactor. The results are shown in Tables 10-14.

TABLE 10
Diazotization time and test results of 5% mass concentration
of p-aminobenzenesulfonic acid

| | The color development time of the test | | | | | | | | |
|---|---|---|---|---|---|---|---|---|---|
| Diazotization | paper kit of the present disclosure(s) | | | | | | | | |
| time (s) | I | II | III | IV | V | VI | VII | VIII | IX |
| 10 | 1 | 2 | 3 | 1 | 2 | 3 | — | — | — |
| 20 | 1 | 2 | 3 | — | — | — | — | — | — |
| 30 | 1 | 2 | 3 | — | — | — | — | — | — |

TABLE 11
Diazotization time and test results of 10% mass concentration
of p-aminobenzenesulfonic acid

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | — | — | — |
| 20 | 1 | 2 | 3 | — | — | — | — | — | — |
| 30 | 1 | 2 | 3 | — | — | — | — | — | — |

TABLE 12
Diazotization time and test results of 15% mass concentration
of p-aminobenzenesulfonic acid

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | — | — | — |
| 20 | 1 | 2 | 3 | — | — | — | — | — | — |
| 30 | 1 | 2 | 3 | — | — | — | — | — | — |

TABLE 13
Diazotization time and test results of 20% mass concentration
of p-aminobenzenesulfonic acid

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | 1 | 2 | 3 |
| 20 | 1 | 2 | 3 | 1 | 2 | 3 | — | — | — |
| 30 | 1 | 2 | 3 | — | — | — | — | — | — |
| 40 | 1 | 2 | 3 | — | — | — | — | — | — |

TABLE 14
Diazotization time and test results of 25% mass concentration
of p-aminobenzenesulfonic acid

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | 1 | 2 | 3 |
| 20 | 1 | 2 | 3 | 1 | 2 | 3 | — | — | — |
| 30 | 1 | 2 | 3 | — | — | — | — | — | — |
| 40 | 1 | 2 | 3 | — | — | — | — | — | — |

The results in Tables 10-14 show that for mass concentrations of p-aminobenzenesulfonic acid of 5%, 10% and 15%, respectively, the p-methoxybenzaldehyde test paper sheets numbered VII, VIII and IX had not changed color in 10 s, indicating that the mass concentration of p-aminobenzenesulfonic acid became lower than 1%; for mass concentrations of p-aminobenzenesulfonic acid of 5%, 10% and 15%, respectively, the p-hydroxybenzaldehyde test paper sheets numbered IV, V and VI and the p-methoxybenzaldehyde test paper sheets numbered VII, VIII and IX had not changed color in 20 s, indicating that the mass concentration of p-aminobenzenesulfonic acid became lower than 0.1%, and the reaction was considered to be complete. For mass concentrations of p-aminobenzenesulfonic acid of 20% and 25%, respectively, the p-hydroxybenzaldehyde test paper sheets numbered IV, V and VI and the p-methoxybenzaldehyde test paper sheets numbered VII, VIII and IX had not changed color in 30 s, indicating that the mass concentration of p-aminobenzenesulfonic acid became lower than 0.1%, and the reaction was considered to be complete.

### Example 13

The para-ester was prepared into aqueous solutions with mass concentrations of 5%, 10%, 15%, 20% and 25% respectively, and sodium nitrite and hydrochloric acid were prepared into aqueous solutions according to a molar ratio of para-ester:sodium nitrite:hydrochloric acid of 1:1.1:2.5. The feeding speed of the feeding pump was set to maintain the molar ratio of para-ester:sodium nitrite:hydrochloric acid of 1:1.05:2.5. The three reaction solutions were fed into the reactor according to the aforesaid ratio, and the reaction results were detected by the test paper kit of the invention in 10 s, 20 s and 30 s respectively as the materials flowed through the reactor. The results are shown in Tables 15-19.

TABLE 15
Diazotization time and test results of 5% mass concentration
of para-ester

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | — | — | — |
| 20 | 1 | 2 | 3 | — | — | — | — | — | — |
| 30 | 1 | 2 | 3 | — | — | — | — | — | — |

TABLE 16
Diazotization time and test results of 10% mass concentration
of para-ester

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | — | — | — |
| 20 | 1 | 2 | 3 | — | — | — | — | — | — |
| 30 | 1 | 2 | 3 | — | — | — | — | — | — |

TABLE 17
Diazotization time and test results of 15% mass concentration
of para-ester

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | — | — | — |
| 20 | 1 | 2 | 3 | — | — | — | — | — | — |
| 30 | 1 | 2 | 3 | — | — | — | — | — | — |

TABLE 18
Diazotization time and test results of 20% mass concentration
of para-ester

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | 1 | 2 | 3 |
| 20 | 1 | 2 | 3 | 1 | 2 | 3 | — | — | — |
| 30 | 1 | 2 | 3 | — | — | — | — | — | — |
| 40 | 1 | 2 | 3 | — | — | — | — | — | — |

TABLE 19
Diazotization time and test results of 25% mass concentration
of para-ester

| | The color development time of the test | | | | | | | | |
|---|---|---|---|---|---|---|---|---|---|
| Diazotization | paper kit of the present disclosure (s) | | | | | | | | |
| time (s) | I | II | III | IV | V | VI | VII | VIII | IX |
| 10 | 1 | 2 | 3 | 1 | 2 | 3 | 1 | 2 | 3 |
| 20 | 1 | 2 | 3 | 1 | 2 | 3 | — | — | — |
| 30 | 1 | 2 | 3 | — | — | — | — | — | — |
| 40 | 1 | 2 | 3 | — | — | — | — | — | — |

The test results in Tables 15-19 show that for mass concentrations of para-ester of 5%, 10% and 15%, respectively, the p-methoxybenzaldehyde test paper sheets numbered VII, VIII and IX had not changed color in 10 s, indicating that the mass concentration of para-ester was lower than 1% at this point; for mass concentrations of para-ester of 20% and 25%, respectively, the p-hydroxybenzaldehyde test paper sheets numbered IV, V and VI and the p-methoxybenzaldehyde test paper sheets numbered VII, VIII and IX had not changed color in 30 s, indicating that the mass concentration of para-ester was lower than 0.1%, and the reaction was considered to be complete.

### Example 14

The mono-condensate was prepared into aqueous solutions with mass concentrations of 5%, 10%, 15%, 20% and 25%, respectively, and sodium nitrite and hydrochloric acid were prepared into aqueous solutions according to a molar ratio of mono-condensate:sodium nitrite:hydrochloric acid of 1:1.05:2.3. The feeding speed of the feeding pump was set to maintain the molar ratio of mono-condensate:sodium nitrite:hydrochloric acid of 1:1.05:2.3. The three reaction solutions were fed into the reactor according to the aforesaid ratio, and the reaction results were detected by the test paper kit of the invention in 10 s, 20 s and 30 s, respectively as the materials flowed through the reactor. The results are shown in Tables 20-24.

TABLE 20
Diazotization time and test results of 5% mass concentration
of mono-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 21
Diazotization time and test results of 10% mass concentration
of mono-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 22
Diazotization time and test results of 15% mass concentration
of mono-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 23
Diazotization time and test results of 20% mass concentration
of mono-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 24
Diazotization time and test results of 25% mass concentration
of mono-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

The test results in Tables 20-24 show that for mass concentrations of mono-condensate of 5%, 10%, 15%, 20% and 25%, respectively, the p-hydroxybenzaldehyde test paper sheets numbered IV, V and VI and the p-methoxybenzaldehyde test paper sheets numbered VII, VIII and IX had not changed color in 10 s, indicating that the mass concentration of the mono-condensate was lower than 0.1%, and the reaction was considered to be complete.

### Example 15

The di-condensate was prepared into aqueous solutions with mass concentrations of 5%, 10%, 15%, 20% and 25%, respectively, and sodium nitrite and hydrochloric acid were prepared into aqueous solutions according to a molar ratio of di-condensate:sodium nitrite:hydrochloric acid of 1:1.05:2.3. The feeding speed of the feeding pump was set to maintain the molar ratio of di-condensate:sodium nitrite:hydrochloric acid of 1:1.05:2.3. The three reaction solutions were fed into the reactor according to the aforesaid ratio, and the reaction results were detected by the test paper kit of the invention in 10 s, 20 s and 30 s as the materials flowed through the reactor respectively. The results are shown in Tables 25-29.

TABLE 25
Diazotization time and test results of 5% mass concentration
of di-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 26
Diazotization time and test results of 10% mass concentration
of di-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 27
Diazotization time and test results of 15% mass concentration
of di-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 28
Diazotization time and test results of 20% mass concentration
of di-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

TABLE 29
Diazotization time and test results of 25% mass concentration
of di-condensate

| | The color development time of the | | | | | | | | |
|---|---|---|---|---|---|---|---|---|---|
| Diazotization | test paper kit (s) | | | | | | | | |
| time (s) | I | II | III | IV | V | VI | VII | VIII | IX |
| 10 | 1 | 2 | 3 | — | — | — | — | — | — |
| 20 | 1 | 2 | 3 | — | — | — | — | — | — |

For mass concentrations of di-condensate of 5%, 10%, 15%, 20% and 25%, respectively, the p-hydroxybenzaldehyde test paper sheets numbered IV, V and VI and the p-methoxybenzaldehyde test paper sheets numbered VII, VIII and IX had not changed color in 10 s, indicating that the mass concentration of the di-condensate was lower than 0.1%, and the reaction was considered to be complete.

What is claimed is:

1. A test paper kit for rapid graded quantitative detection of aromatic primary amine content in an acidic solution, comprising 9 independent test paper sheets I-IX, wherein the test paper sheets are respectively obtained by soaking filter paper in the following solutions and then drying the filter paper;
the test paper sheets I, II and III are soaked in absolute ethanolic solutions of p-dimethylaminobenzaldehyde with concentrations of 11.9-14.9 g/L, 4.5-7.5 g/L and 1.8-2.1 g/L, respectively;
the test paper sheets IV, V and VI are soaked in absolute ethanolic solutions of p-hydroxybenzaldehyde with concentrations of 32.0-34.9 g/L, 26.8-29.0 g/L and 12.2-23.0 g/L, respectively; and
the test paper sheets VII, VIII and IX are soaked in absolute ethanolic solutions of p-methoxybenzaldehyde with concentrations of 31.0-35.4 g/L, 27.2-28.0 g/L and 14.0-25.0 g/L, respectively.

2. The test paper kit according to claim 1, wherein a color development time of the test paper sheets I, IV and VII is in 1 s; a color development time of the test paper sheets II, V and VIII is in 2 s; and a color development time of the test paper sheets III, VI and IX is in 3 s.

3. The test paper kit according to claim 1, wherein:
the test paper sheets I, II and III are soaked in absolute ethanolic solutions of p-dimethylaminobenzaldehyde with concentrations of 12.5 g/L, 7.0 g/L and 2.0 g/L, respectively;
the test paper sheets IV, V and VI are soaked in absolute ethanolic solutions of p-hydroxybenzaldehyde with concentration of 34.0 g/L, 28.0 g/L and 20.0 g/L, respectively; and
the test paper sheets VII, VIII and IX are soaked in absolute ethanolic solutions of p-methoxybenzaldehyde with concentrations of 34.0 g/L, 27.5 g/L and 23.0 g/L, respectively.

4. The test paper kit according to claim 1, wherein the test paper kit comprises 9 independent test paper sheets I-IX, the test paper sheets are respectively obtained by soaking filter paper in the corresponding solutions for 20-300 min and then air drying the filter paper at room temperature.

5. A method for rapid graded quantitative detection of aromatic primary amine content in an acidic aqueous solution, comprising the following steps: adding dropwise an acidic solution containing aromatic primary amine to-be-detected onto the 9 test paper sheets I-IX according to claim 1 respectively, and observing whether the test paper sheets change color or not;
when only 3 test paper sheets I-III change color, a mass concentration of aromatic primary amine in the aqueous solution to-be-detected is 0.01% to <0.1%;
when only 6 test paper sheets I-VI change color, a mass concentration of aromatic primary amine in the aqueous solution to-be-detected is 0.1% to <1%; and
when all 9 test paper sheets I-IX change color, a mass concentration of aromatic primary amine in the aqueous solution to-be-detected is ≥1%.

6. A method for rapid graded quantitative detection of aromatic primary amine content in a diazotization reaction solution, comprising the following steps: adding dropwise a diazotization reaction solution to-be-detected onto the 9 test paper sheets I-IX according to claim 1, and observing whether the test paper sheets change color or not;
when only 3 test paper sheets I-III change color, a mass concentration of aromatic primary amine in the reaction solution to-be-detected is 0.01% to <0.1%;
when only 6 test paper sheets I-VI change color, a mass concentration of aromatic primary amine in the reaction solution to-be-detected is 0.1% to <1%;
when all 9 test paper sheets I-IX change color, a mass concentration of aromatic primary amine in the reaction solution to-be-detected is ≥1%.
